(19) United States
(12) Patent Application Publication
(10) Pub. No.: US 2023/0297499 A1
(43) Pub. Date: Sep. 21, 2023

(54) LOCATING A MEMORY UNIT ASSOCIATED WITH A MEMORY ADDRESS UTILIZING A MAPPER

(71) Applicant: NVIDIA Corporation, Santa Clara, CA (US)

(72) Inventors: William James Dally, Incline Village, NV (US); Stephen William Keckler, Austin, TX (US); Carl Thomas Gray, Apex, NC (US); James Michael O’Connor, Austin, TX (US)

(21) Appl. No.: 17/581,687

(22) Filed: Jan. 21, 2022

(51) Int. Cl. G06F 12/02

(52) U.S. Cl. CPC G06F 12/0238; G06F 2212/657

(57) ABSTRACT

A mapper within a single-level memory system may facilitate memory localization to reduce the energy and latency of memory accesses within the single-level memory system. The mapper may translate a memory request received from a processor for implementation at a data storage entity, where the translating identifies a data storage entity and a starting location within the data storage entity where the data associated with the memory request is located. This data storage entity may be co-located with the processor that sent the request, which may enable the localization of memory and significantly improve the performance of memory usage by reducing an energy of data access and increasing data bandwidth.

### FIELD OF THE INVENTION

The present invention relates to system memory, and more particularly to implementing memory localization within a computing system.

### BACKGROUND

Current high-performance computing (HPC) and graphics are capable of utilizing more memory bandwidth than can currently be provided given modern system memory implementations. For example, many HPC applications have a byte to FLOP (B:F) ratio between 8:1 and 1:1 - that is, they require from one to eight bytes from main memory for every floating-point operation performed. In another example, the High-Performance Conjugate Gradients (HPCG) Benchmark, has a B:F ratio greater than four. Modern graphics processing units (GPUs) that provide 10 FLOPS per B/s of memory bandwidth create a significant memory limitation for such applications.

There is therefore a need for an improved high-performance memory implementation within a processing environment, as well as a means to implement memory accesses in a localized manner within such an environment in order to reduce the energy and latency of memory accesses.

### BRIEF DESCRIPTION OF THE DRAWINGS

FIG. 1 illustrates an exemplary one-level data storage sub-system, in accordance with an embodiment.

FIG. 2 illustrates an exemplary one-level memory system, in accordance with an embodiment.

FIG. 3 illustrates a flowchart of a method for mapping a virtual address to a data storage entity, in accordance with an embodiment.

FIG. 4 illustrates an exemplary mapping for a 3D matrix, in accordance with an embodiment.

FIG. 5 illustrates a parallel processing unit, in accordance with an embodiment.

FIG. 6A illustrates a general processing cluster within the parallel processing unit of FIG. 5, in accordance with an embodiment.

FIG. 6B illustrates a memory partition unit of the parallel processing unit of FIG. 5, in accordance with an embodiment.

FIG. 7A illustrates the streaming multi-processor of FIG. 6A, in accordance with an embodiment.

FIG. 7B is a conceptual diagram of a processing system implemented using the PPU of FIG. 5, in accordance with an embodiment.

FIG. 7C illustrates an exemplary system in which the various architecture and/or functionality of the various previous embodiments may be implemented.

### DETAILED DESCRIPTION

A single-level memory system is provided with the main memory of the system consisting of a number of memory banks located near each streaming multiprocessor (SM). In one embodiment, the memory banks may be stacked on top of the GPU chip. Such an arrangement can provide a significantly improved B:F ratio when compared to contemporary GPUs (e.g., a B:F ratio of ~4:1) as well as a much lower transfer energy per bit (e.g., 100fJ/bit vs 5pJ/bit).

Additionally, a mapping module within the single-level memory system may facilitate memory localization to reduce the energy and latency of memory accesses within the single-level memory system. More specifically, the mapper may translate a memory request received from a processor for implementation at a data storage entity, where the translating identifies a data storage entity and a starting location within the data storage entity where the data associated with the memory request is located. This data storage entity may be co-located with the processor that sent the request, which may enable the localization of memory and significantly improve the performance of memory usage by reducing an energy of data access and increasing data bandwidth.

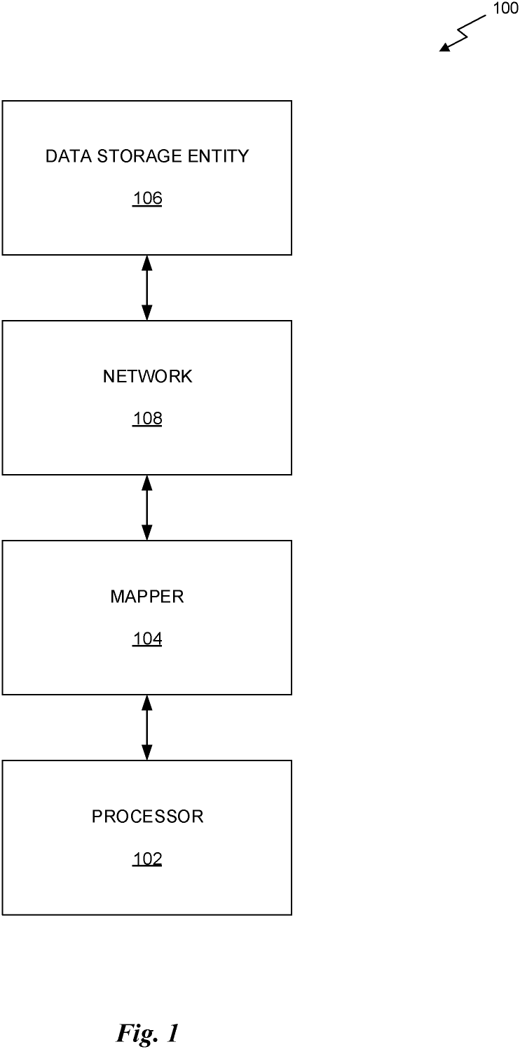

FIG. 1 illustrates an exemplary one-level data storage sub-system 100, according to one exemplary embodiment. As shown, a processor 102, mapper 104, and data storage entity 106 are all co-located within the data storage sub-system 100. For example, the processor 102, mapper 104, and data storage entity 106 may or may not be integrated within the data storage sub-system 100. In one embodiment, a plurality of data storage sub-systems 100 may be implemented within a larger data storage system (e.g., a one-level memory system, etc.).

Additionally, in one embodiment, the processor 102 may include a streaming multiprocessor (SM). For example, the processor 102 may include a graphics processing unit (GPU) streaming multiprocessor. In another embodiment, the processor 102 may include a central processing unit (CPU).

Further, in one embodiment, the data storage entity 106 may include any hardware utilized to store digital data. For example, the data storage entity may include an individual memory block such as an individual memory sub-array that is located in a stacked configuration on top of the processor 102. Of course, however, the data storage entity 106 may include any hardware for storing data, such as flash memory, a storage disk, a solid-state drive, etc. In another embodiment, the data storage entity 106 may include a frame-buffer bank in a GPU, a memory channel in a CPU, etc.

Further still, in one embodiment, the mapper 104 may include computing hardware that facilitates the retrieval of data from the data storage entity 106. For example, the mapper 104 may receive a read or write request from the processor 102. In another example, the mapper 104 may receive a read or write request from another data storage sub-system via a network connection 108. In another embodiment, the network connection 108 may forward a request directly to the data storage entity 106 without passing the request through the mapper 104. In yet another embodiment, the mapper 104 may include a circuit in communication with processor 102 and the data storage entity 106. This communication may be direct or indirect. In another embodiment, the mapper 104 may include a specialized circuit. For example, the mapper 104 may include a specialized circuit on the same die as the processor 102 and the network connection 108. In yet another embodiment, the mapper 104 may include a general processor.

Also, in one embodiment, the mapper 104 may identify a virtual address included within the read or write request. In another embodiment, the mapper 104 may identify a portion of the virtual address as the segment number, and may locate a segment descriptor in a lookup table, utilizing the segment number. In yet another embodiment, using the segment descriptor, the mapper 104 may identify the data storage entity 106 (or another data storage entity of another sub-system) and a starting location within the data storage entity 106 (e.g., a location where the data read or write is to be performed). In another example, the mapper 104 may identify the data storage sub-system 100 containing the data storage entity 106, as well as the starting location within the data storage entity 106. In still another embodiment, the mapper 104 may implement the read or write request utilizing the identified data storage entity and starting location within the data storage entity.

In addition, in one embodiment, the mapper 104 may include computing hardware that facilitates the storage of data to the data storage entity 106. For example, given an N-dimensional array to be stored within the system, the mapper 104 may map the N-dimensional array such that one N-dimensional sub-array of the N-dimensional array is stored within the data storage entity 106. In another example, the N-dimensional sub-arrays of the N-dimensional array may be stored within a predetermined segment (portion) of the data storage entity 106.

Further, in one embodiment, the mapper 104 may perform a predetermined function (e.g., a shuffle operation) on bits of an address field for stored data (e.g., an N-dimensional array) to form a data storage entity address for the data (e.g., that indicates the data storage entity 106 storing the data or the data storage sub-system 100 containing the data storage entity 106) and an offset location within the data storage entity 106 for the data (e.g., where the data is located within the data storage entity 106).

Further still, in one embodiment, the mapper 104 may store a segment descriptor (e.g., in a lookup table) that is associated with a predetermined segment (portion) of the virtual address space where the N-dimensional array is stored. In another embodiment, the segment descriptor may indicate how to use the bits of a virtual address to identify the data storage entity 106 where the data is stored or the data storage sub-system 100 containing the data storage entity 106 where the data is stored, as well as the offset location within the data storage entity 106 where the data is located. In yet another embodiment, the mapper may store a plurality of segment descriptors, where each segment descriptor is associated with an N-dimensional matrix stored within a data storage entity in communication with the mapper 104.

Also, in one embodiment, given an N-dimensional array to be stored within the system, the mapper 104 may map the N-dimensional array such that N-dimensional sub-arrays of the N-dimensional array are stored across a plurality of different data storage entities. For example, the N-dimensional sub-arrays of the N-dimensional array may be interleaved by dimension at a predetermined granularity across the plurality of different data storage entities. In another embodiment, the N-dimensional sub-arrays of the N-dimensional array may be mapped to a predetermined subset of the plurality of data storage entities.

In this way, the mapper 104 may facilitate memory localization to reduce the energy and latency of memory accesses within a data storage system.

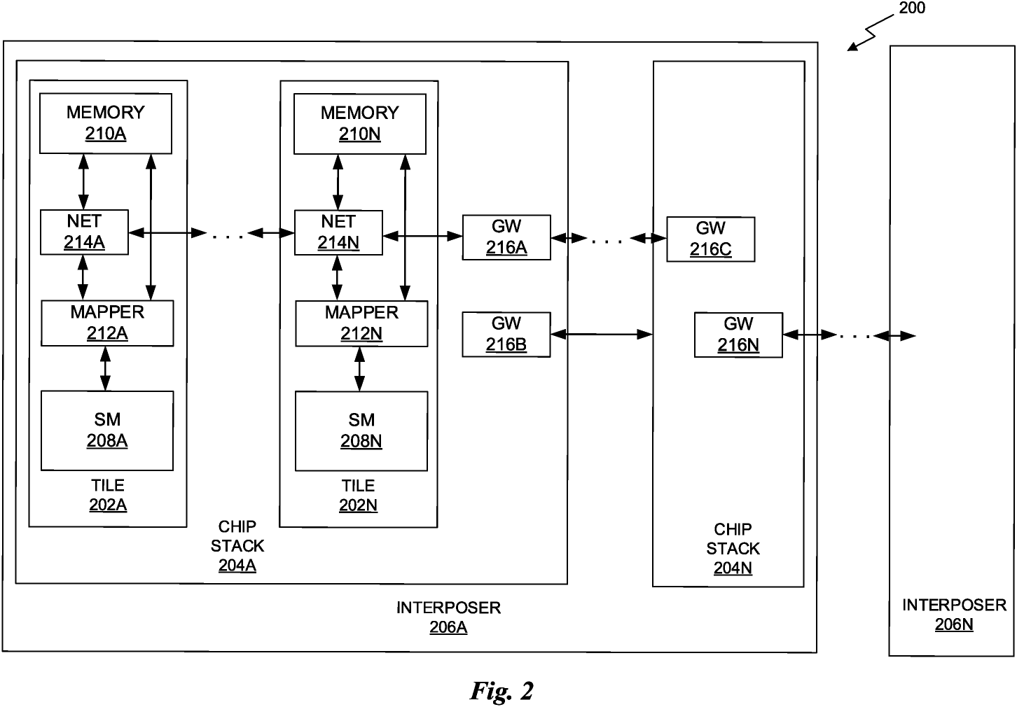

FIG. 2 illustrates an exemplary one-level memory system 200, according to one exemplary embodiment. As shown, the system 200 includes a plurality of interposers 206A-N, where each of the plurality of interposers 206A-N include a plurality of chip stacks 204A-N, and each of the plurality of chip stacks 204A-N include a plurality of tiles 202A-N.

Additionally, on each tile 202A-N, a streaming multiprocessor (SM) 208A-N (or small group of SMs) is co-located with a block of main memory 210A-N. A portion of this block of main memory 210A-N may be mapped into the address space so that the state of one partition of a problem (e.g., a sub-volume of a 3D physics simulation, or a sub-matrix of a matrix calculation) resides entirely within this block of main memory 210A-N. Other portions of the block of main memory 210A-N can be mapped as a cache, or as interleaved memory to hold global state shared by all partitions or to hold a sub-matrix of a different matrix.

Further, memory requests by an SM 208A-N are translated by a corresponding mapper 212A-N that maintains mappings for each memory segment. Segments may be mapped entirely to one block of main memory 210A-N, or interleaved by dimension at a specified granularity across multiple blocks of main memory 210A-N. Local requests are forwarded directly to the corresponding local block of main memory 210A-N (e.g., through the network component 214A-N). Remote requests are directed to the destination block of main memory 210A-N via a network component 214A-N.

In this way, bandwidth between each SM 208A-N (or group) and its local block of main memory 210A-N may be increased. Remote blocks of main memory 210A-N are accessed via an interconnection network using network components 214A-N. In one embodiment, the interconnection network may use a bandwidth taper providing higher bandwidth to other blocks of main memory 210A-N on the same chip stack 204A-N, lower bandwidth to blocks on other chip stacks 204A-N on the same interposer 206A-N, and yet lower bandwidth to blocks on other packages. Communication between chip stacks 204A-N may be implemented via gateways (GWs) 216A-N (e.g., where each gateway may include a network unit that shifts between channels of different bandwidth, etc.).

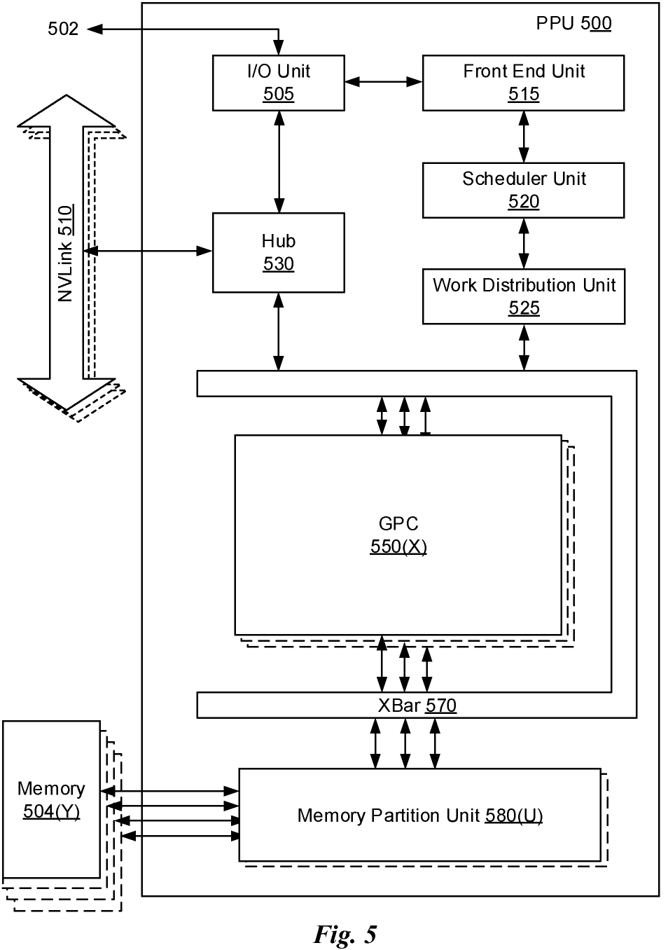

In yet another embodiment, the exemplary one-level memory system 200 may be implemented utilizing a parallel processing unit (PPU) such as the PPU 500 illustrated in FIG. 5.

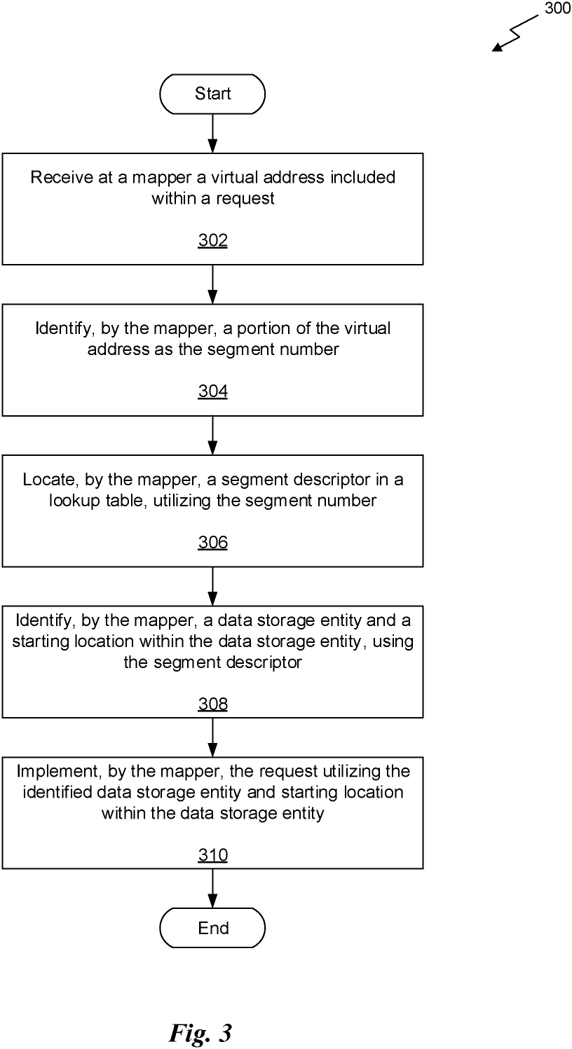

FIG. 3 illustrates a flowchart of a method 300 for mapping a virtual address to a data storage entity, in accordance with an embodiment. Although method 300 is described as being implemented in hardware, the method 300 may also be performed by a program, processing unit, or by a combination of custom circuitry and a program. For example, the method 300 may be executed by a GPU (graphics processing unit), CPU (central processing unit), or any processing element. Furthermore, persons of ordinary skill in the art will understand that any system that performs method 300 is within the scope and spirit of embodiments of the present invention. Further, the method 300 may be performed by the exemplary one-level data storage sub-system 100 of FIG. 1, the exemplary one-level memory system 200 of FIG. 2, etc.

As shown in operation 302, a virtual address included within a request is received at a mapper. In one embodiment, the request may include a memory request. In another embodiment, the memory request may include a read request or a write request. In yet another embodiment, the memory request may include a read request including a virtual address. In still another embodiment, memory request may include a write request having a virtual address and data to be written (and possibly a write mask). In another embodiment, the memory request may be received from a processor (e.g., a streaming multiprocessor of a GPU, a central processing unit (CPU, etc.).

Additionally, as shown in operation 304, the mapper identifies a portion of the virtual address as the segment number. Of course, however, in one embodiment the segment number may be derived from the virtual address without being a fixed field (e.g., a portion) of the virtual address. In another embodiment, the portion may include the address-space identifier (ASID) and the high address bits (a predetermined high portion) of the virtual address. Further, as shown in operation 306, the mapper locates a segment descriptor in a lookup table, utilizing the segment number. In one embodiment, the lookup table may be associative, indexed, etc.

Further still, as shown in operation 308, using the segment descriptor, the mapper identifies a data storage entity and a starting location within the data storage entity. In one embodiment, the mapper may use the segment descriptor to identify a data storage sub-system containing the data storage entity. In another embodiment, the identified data storage entity and starting location within the data storage entity may include a location where the data read or write is to be performed. In yet another embodiment, the data storage entity may include a memory block. For example, the memory block may include an individual memory sub-array that is located in a stacked configuration on top of a processor.

Also, in one embodiment, the data storage entity may include any hardware for storing data, such as flash memory, a storage disk, a solid-state drive, etc. In another embodiment, the data storage entity may be co-located with the processor that sent the request. In yet another embodiment, the segment descriptor may indicate how to use the bits of the virtual address to identify a data storage sub-system (e.g., a tile, etc.) via a sub-system address (e.g., a tile address) and an offset location within a corresponding data storage entity of the data storage sub-system where the data is located.

For example, a first number of predetermined bits within the segment descriptor may be used to determine an offset from a base data storage sub-system (e.g., to identify a data storage sub-system that stores the data associated with the memory request). In another example, a second number of predetermined bits within the segment descriptor may be used to determine an offset from a base location within the identified data storage sub-system (e.g., to identify a location within a data storage entity that stores the data associated with the memory request).

In addition, in one embodiment, the segment descriptor may be associated with a predetermined memory segment. For example, the memory segment may include a portion of a memory block allocated for specific data (e.g., a specific N-dimensional array). In another example, the specific data may be associated with a predetermined portion of a computation task (e.g., a sub-volume of a 3D physics simulation, a sub-matrix of a matrix calculation, etc.). In another embodiment, the lookup table may include segment descriptors for a plurality of different memory segments.

Furthermore, as shown in operation 310, the mapper implements the request utilizing the identified data storage entity and starting location within the data storage entity. In one embodiment, the mapper may translate the memory request to identify the data storage entity and the starting location within the data storage entity. In another embodiment, the mapper may send the translated memory request to the data storage entity for implementation by the data storage entity.

In this way, the mapper may translate a memory request received from a processor for implementation at a data storage entity. The translating may identify a data storage entity and a starting location within the data storage entity where the data associated with the memory request is located. This data storage entity may be co-located with the processor that sent the request. This may enable the localization of memory, which may improve the performance of memory usage by reducing an energy of data access and increasing data bandwidth.

In yet another embodiment, the aforementioned functionality may be performed utilizing a parallel processing unit (PPU) such as the PPU 500 illustrated in FIG. 5.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

### Local, One-Level Memory for Ultra-High Memory Bandwidth

In one embodiment of the one-level data storage sub-system 100 shown in FIG. 1 and/or the single-level memory system 200 illustrated in FIG. 2, to utilize the bandwidth advantage of stacking, threads and data may be co-located so a given thread makes most of its accesses to the local DRAM. For regular codes this can be done by subdividing N-dimensional matrices into N-dimensional sub-matrices in each local region. For irregular codes this may be accomplished by partitioning the cells and launching a thread at the location of the cell it is operating on.

Additionally, in one embodiment, a mapping unit/module may route address bits into tile address and local address, which facilitates interleaving in a manner that preserves locality for N-dimensional matrices.

For example, in the context of the one-level data storage sub-system 100 shown in FIG. 1 and/or the single-level memory system 200 illustrated in FIG. 2, a mapping unit (e.g., a mapper) may interpret an ASID and high address bits within a virtual address included within a request as a segment number that is used to look up a segment descriptor. In another embodiment, the segment descriptor may have a plurality of fields. Table 1 illustrates exemplary segment descriptor fields in accordance with one exemplary embodiment.

TABLE 1

| | |
|---|---|
| BT: Base tile | The segment starts on this tile |
| BA: Base address | The segment starts at this location in the base tile |
| L: Length | The length of the segment in bytes - accesses beyond the length raise an exception. |
| L1: Bits per tile 1 | The log base 2 of the number of cache lines per tile on the first interleave |
| T1: Tile bits 1 | The number of bits used to select a tile on the first interleave |
| L2: Bits per tile 2 | The number of bits used to select a location within the tile on the second interleave |
| T2: Tile bits 2 | The number of bits used to select a tile on the second interleave |
| L3: Bits per tile 3 | The number of bits used to select a location within the tile on the third interleave |

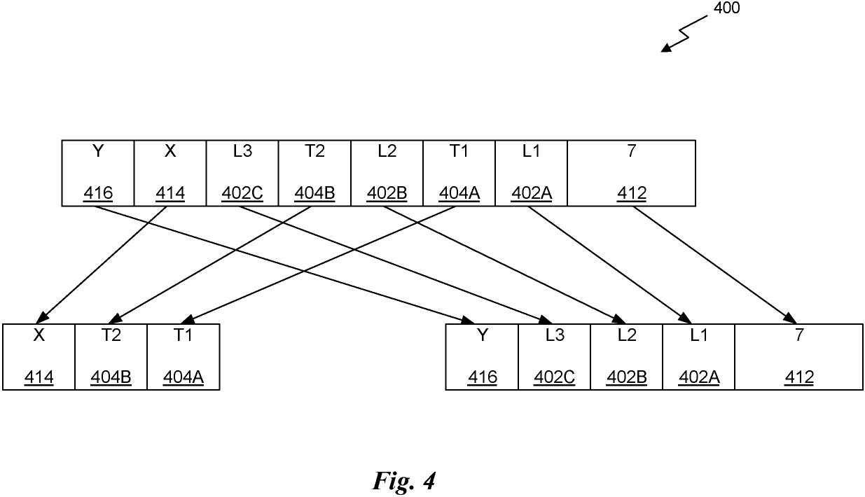

FIG. 4 illustrates an exemplary mapping 400 for a 3D matrix, according to one exemplary embodiment. As shown, the Lx bits and Tx bits of a segment descriptor describe how to use the address bits 406 to form a tile address and a location within the tile. These fields of the segment descriptor specify the widths of bit fields that are alternately used to form the offset from the base tile 408 and the offset from the base location within the tile 410. The bottom L1 bit 402A and +7 bits 412 are location bits. The next T1 bits 404A are tile bits, followed by L2 location bits 402B, T2 tile bits 404B, and L3 location bits 402C. The next X bits 414 are tile bits
where T1 404A +T2 404B +X 414 is the base-2 log of the number of tiles allocated. The remaining bits (Y 416) are location bits.

Based on a mapping of the address bits 406, the local address is calculated as follows:

LA = BA + A[0:L1+6]:A[L1+T1+7:L1+T1+L2+6]:A[L1+T1+L2+T2+7:L1+ T1+L2+T2+L3+6] + TileQuotient

Additionally, the tile is selected as follows:

T = (BT + A[L1+7:L1+T1+6]:A[L1+T1+L2+7:L1+T1+L2+T2+6]:A[L1+T1+L2 +T2+L3+7:*]) % NumTiles

In one embodiment, if it is desired to map a segment so address bits 12-15 select the “x” coordinate of a tile and address bits 24-27 select a “y” coordinate of a tile, bits 0-11 and 16-23 may be concatenated to form the address within the tile. The segment descriptor may be set with L1=4, T1=4, L2=4, T2=4, L3=0.

Also, in one embodiment, the tile address may be computed by computing a modulo of the number of tiles (e.g., the remainder of dividing the tile address by the number of tiles, which must be a power of 2). The quotient of this division may be appended to the local address. This is shown as the division of the upper bits into the X field 414 and Y field 416 in FIG. 4.

### Programming Model

To utilize the high local bandwidth of the single-level memory, placement of data and threads must be controlled to ensure locality. Dense, static arrays can be “tiled” across the physical tiles in one, two, or three dimensions. For example, the following commands could be specified:

double a[M][N] ;
map a[X][X] ;

The above commands map a 2D array with dimensions M x N onto X by X tiles each of M/X x N/X. The mapping unit described above supports access into this structure with linear addresses.

To exploit locality, a loop nest operating on array “a” may be divided into sub-loops for each tile that run in parallel on the local tile. The compiler may perform this mechanical division. If a thread operates on like indices of multiple dense arrays, they may be aligned so that accesses to all of the arrays are local.

Once the data is explicitly placed on tiles, threads may be run where the data is located. This may be done implicitly or explicitly. Consider a MxV loop:

forall j = 0..N-1
forall i = 0..M-1
o[i] += a[i][j] * v[j] ; // reduction

With array “a” mapped as above, the compiler may split this into X^2 sub-loops, one for each tile. Each of the subloops may be executed on the SM co-located with its part of the array, as shown below.

forall tx = 0..X-1
forall ty = 0..Y-1
forall i = 0..NX-1
forall j = 0..NY-1
ol[i+ty*NY][tx] += a[i+ty*NY][j+tx*NX]*v[j+tx*NX];
forall tx = 0..X-1
forall ty = 0..Y-1
forall j = 0..NY-1
o[i+ty*NY] += ol[i+ty*NY][tx] ;

For irregular codes (e.g., certain fluids codes), graph structures may be partitioned into tiles using standard graph-partitioning software. This may be accomplished by declaring the structures as a 1D array and mapping as described above. Codes with inherent 3D structure (e.g., the grid of a fluid code) may achieve high locality in this manner. Once the structure is partitioned, threads are invoked on the SM co-located with the element of the structure being processed. In the following loop:

forall control_volume in volumes
evaluate_flux(control_volume)

Each invocation of procedure evaluate_flux launches a thread on the SM co-located with the argument. Sufficient threads may be located on each SM to fill a thread array of sufficient size to keep the SM busy. Each of these threads may make references to adjacent (in the grid) control volumes. However, the majority of these references will be local references, and the remainder will be cached.

An allocation mechanism that specifies location may be used to localize individual control volumes. In one embodiment, this may be done by allocating a tiled 1D array (which allocates a contiguous fraction of the array on each tile) and then remapping the control volumes into these tiles. For example, a grid may be initially read as an array of neighbor lists. A partitioner may then be run on this grid to assign each node to a tile. This sets the tile member of each node in the example code below.

The node array may then be scanned to assign each node an offset within its tile using the auxiliary array last_offset that records the last offset assigned for each tile. Next, the neighbor lists may be fixed to point to the new location for each node (tile*TILE_SZ + offset) . Each node may then be placed at the index where it belongs. This is done in place by using temp_node to hold the node displaced by the last node moved, as shown below.

typedef struct node {
int neighbor[4] ;
int tile ;
int offset;
} node_t ;
node_t nodes[NR_NODES] ;
int last_offset[NR_TILES] ;
node_t temp_node ;

read_graph(nodes) ;
partition_graph(nodes) ;
assign_offsets(nodes) ;
fix_pointers(nodes) ;
shuffle_nodes(nodes) ;

Each of these routines may be done in parallel using a temp_node per worker and making sure the updates to last_offset are atomic.

### Parallel Processing Architecture

FIG. 5 illustrates a parallel processing unit (PPU) 500, in accordance with an embodiment. In an embodiment, the PPU 500 is a multi-threaded processor that is implemented on one or more integrated circuit devices. The PPU 500 is a latency hiding architecture designed to process many threads in parallel. A thread (i.e., a thread of execution) is an instantiation of a set of instructions configured to be executed by the PPU 500. In an embodiment, the PPU 500 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 500 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 500 may be configured to accelerate thousands of High Performance Computing (HPC), data center, and machine learning applications. The PPU 500 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 5, the PPU 500 includes an Input/Output (I/O) unit 505, a front end unit 515, a scheduler unit 520, a work distribution unit 525, a hub 530, a crossbar (Xbar) 570, one or more general processing clusters (GPCs) 550, and one or more partition units 580. The PPU 500 may be connected to a host processor or other PPUs 500 via one or more high-speed NVLink 510 interconnect. The PPU 500 may be connected to a host processor or other peripheral devices via an interconnect 502. The PPU 500 may also be connected to a local memory comprising a number of memory devices 504. In an embodiment, the local memory may comprise a number of dynamic random access memory (DRAM) devices. The DRAM devices may be configured as a high-bandwidth memory (HBM) subsystem, with multiple DRAM dies stacked within each device.

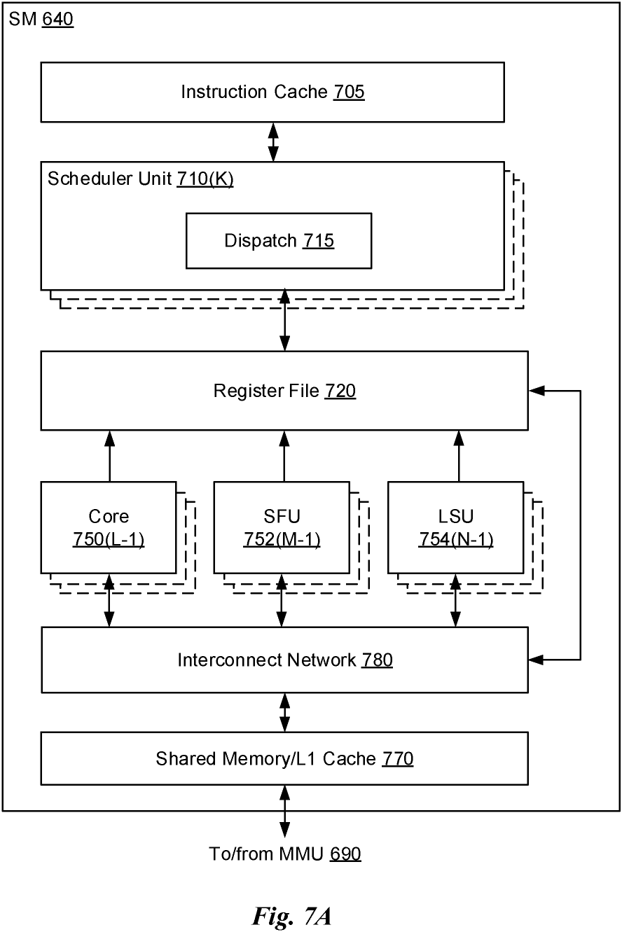

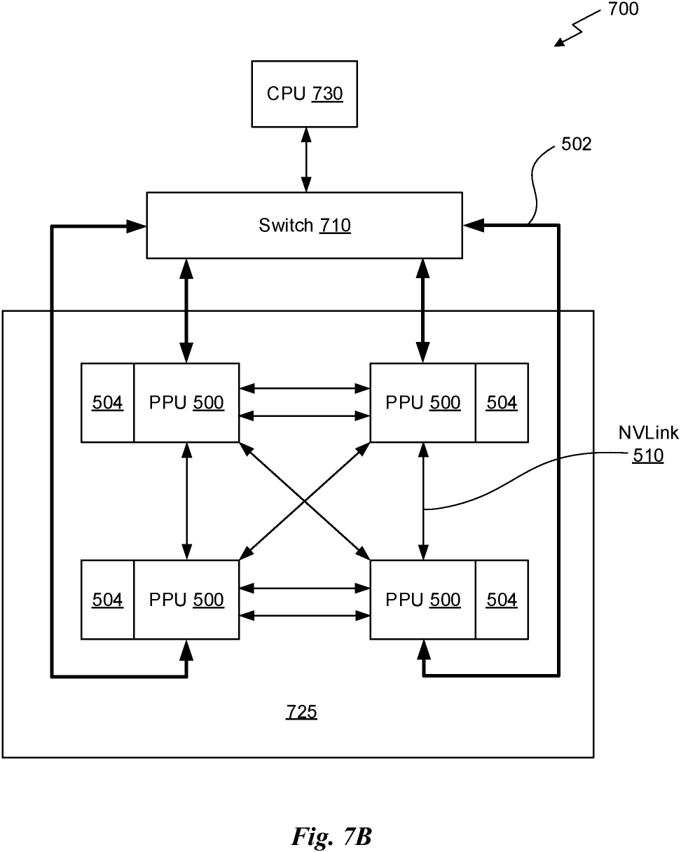

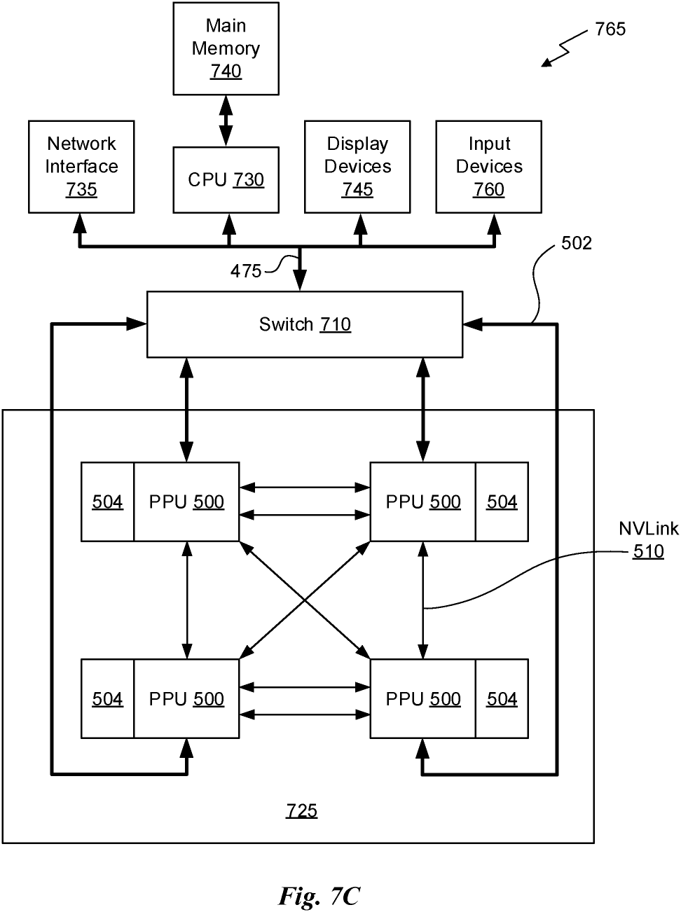

The NVLink 510 interconnect enables systems to scale and include one or more PPUs 500 combined with one or more CPUs, supports cache coherence between the PPUs 500 and CPUs, and CPU mastering. Data and/or commands may be transmitted by the NVLink 510 through the hub 530 to/from other units of the PPU 500 such as one or more copy engines, a video encoder, a video decoder, a power management unit, etc. (not explicitly shown). The NVLink 510 is described in more detail in conjunction with FIG. 7B.

The I/O unit 505 is configured to transmit and receive communications (i.e., commands, data, etc.) from a host processor (not shown) over the interconnect 502. The I/O unit 505 may communicate with the host processor directly via the interconnect 502 or through one or more intermediate devices such as a memory bridge. In an embodiment, the I/O unit 505 may communicate with one or more other processors, such as one or more the PPUs 500 via the interconnect 502. In an embodiment, the I/O unit 505 implements a Peripheral Component Interconnect Express (PCIe) interface for communications over a PCIe bus and the interconnect 502 is a PCIe bus. In alternative embodiments, the I/O unit 505 may implement other types of well-known interfaces for communicating with external devices.

The I/O unit 505 decodes packets received via the interconnect 502. In an embodiment, the packets represent commands configured to cause the PPU 500 to perform various operations. The I/O unit 505 transmits the decoded commands to various other units of the PPU 500 as the commands may specify. For example, some commands may be transmitted to the front end unit 515. Other commands may be transmitted to the hub 530 or other units of the PPU 500 such as one or more copy engines, a video encoder, a video decoder, a power management unit, etc. (not explicitly shown). In other words, the I/O unit 505 is configured to route communications between and among the various logical units of the PPU 500.

In an embodiment, a program executed by the host processor encodes a command stream in a buffer that provides workloads to the PPU 500 for processing. A workload may comprise several instructions and data to be processed by those instructions. The buffer is a region in a memory that is accessible (i.e., read/write) by both the host processor and the PPU 500. For example, the I/O unit 505 may be configured to access the buffer in a system memory connected to the interconnect 502 via memory requests transmitted over the interconnect 502. In an embodiment, the host processor writes the command stream to the buffer and then transmits a pointer to the start of the command stream to the PPU 500. The front end unit 515 receives pointers to one or more command streams. The front end unit 515 manages the one or more streams, reading commands from the streams and forwarding commands to the various units of the PPU 500.

The front end unit 515 is coupled to a scheduler unit 520 that configures the various GPCs 550 to process tasks defined by the one or more streams. The scheduler unit 520 is configured to track state information related to the various tasks managed by the scheduler unit 520. The state may indicate which GPC 550 a task is assigned to, whether the task is active or inactive, a priority level associated with the task, and so forth. The scheduler unit 520 manages the execution of a plurality of tasks on the one or more GPCs 550.

The scheduler unit 520 is coupled to a work distribution unit 525 that is configured to dispatch tasks for execution on the GPCs 550. The work distribution unit 525 may track a number of scheduled tasks received from the scheduler unit 520. In an embodiment, the work distribution unit 525 manages a pending task pool and an active task pool for each of the GPCs 550. The pending task pool may comprise a number of slots (e.g., 32 slots) that contain tasks assigned to be processed by a particular GPC 550. The active task pool may comprise a number of slots (e.g., 4 slots) for tasks that are actively being processed by the GPCs 550. As a GPC 550 finishes the execution of a task, that task is evicted from the active task pool for the GPC 550 and one of the other tasks from the pending task pool is selected and scheduled for execution on the GPC 550. If an active task has been idle on the GPC 550, such as while waiting for a data dependency to be resolved, then the active task may be evicted from the GPC 550 and returned to the pending task pool while another task in the pending task pool is selected and scheduled for execution on the GPC 550.

The work distribution unit 525 communicates with the one or more GPCs 550 via XBar 570. The XBar 570 is an interconnect network that couples many of the units of the PPU 500 to other units of the PPU 500. For example, the XBar 570 may be configured to couple the work distribution unit 525 to a particular GPC 550. Although not shown explicitly, one or more other units of the PPU 500 may also be connected to the XBar 570 via the hub 530.

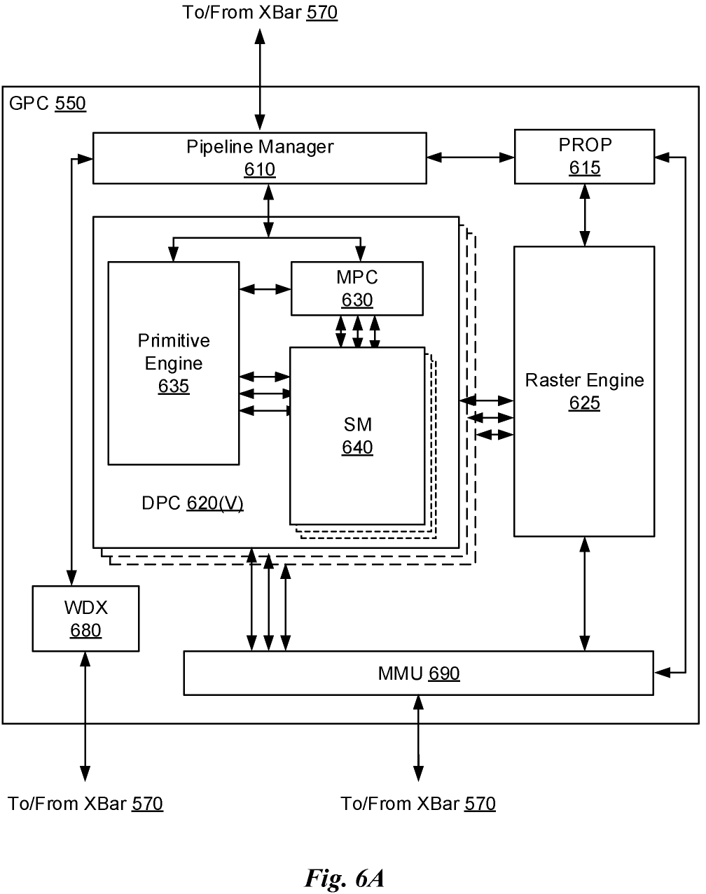

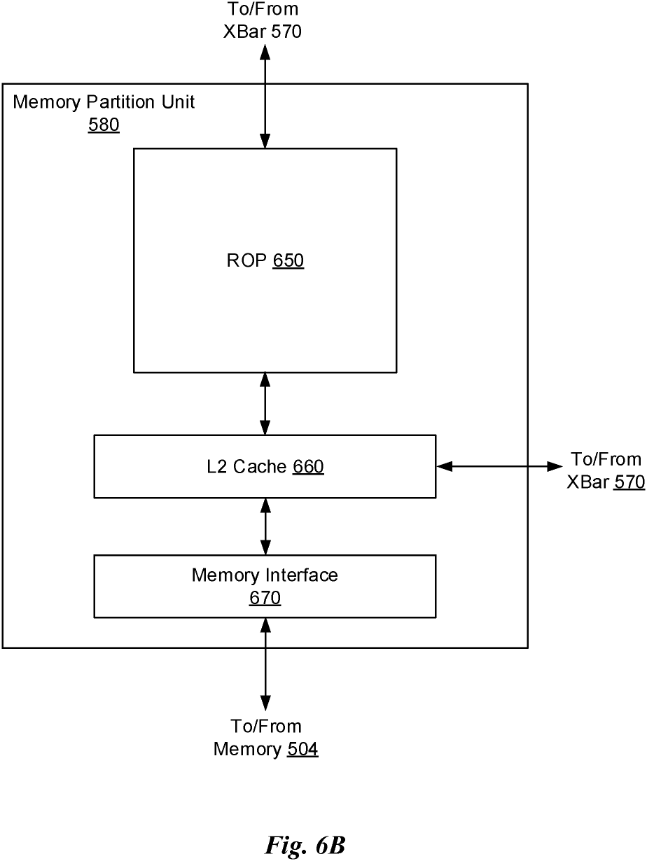

The tasks are managed by the scheduler unit 520 and dispatched to a GPC 550 by the work distribution unit 525. The GPC 550 is configured to process the task and generate results. The results may be consumed by other tasks within the GPC 550, routed to a different GPC 550 via the XBar 570, or stored in the memory 504. The results can be written to the memory 504 via the partition units 580, which implement a memory interface for reading and writing data to/from the memory 504. The results can be transmitted to another PPU 500 or CPU via the NVLink 510. In an embodiment, the PPU 500 includes a number U of partition units 580 that is equal to the number of separate and distinct memory devices 504 coupled to the PPU 500. A partition unit 580 will be described in more detail below in conjunction with FIG. 6B.

In an embodiment, a host processor executes a driver kernel that implements an application programming interface (API) that enables one or more applications executing on the host processor to schedule operations for execution on the PPU 500. In an embodiment, multiple compute applications are simultaneously executed by the PPU 500 and the PPU 500 provides isolation, quality of service (QoS), and independent address spaces for the multiple compute applications. An application may generate instructions (i.e., API calls) that cause the driver kernel to generate one or more tasks for execution by the PPU 500. The driver kernel outputs tasks to one or more streams being processed by the PPU 500. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 7A.

FIG. 6A illustrates a GPC 550 of the PPU 500 of FIG. 5, in accordance with an embodiment. As shown in FIG. 6A, each GPC 550 includes a number of hardware units for processing tasks. In an embodiment, each GPC 550 includes a pipeline manager 610, a pre-raster operations unit (PROP) 615, a raster engine 625, a work distribution crossbar (WDX) 680, a memory management unit (MMU) 690, and one or more Data Processing Clusters (DPCs) 620. It will be appreciated that the GPC 550 of FIG. 6A may include other hardware units in lieu of or in addition to the units shown in FIG. 6A.

In an embodiment, the operation of the GPC 550 is controlled by the pipeline manager 610. The pipeline manager 610 manages the configuration of the one or more DPCs 620 for processing tasks allocated to the GPC 550. In an embodiment, the pipeline manager 610 may configure at least one of the one or more DPCs 620 to implement at least a portion of a graphics rendering pipeline. For example, a DPC 620 may be configured to execute a vertex shader program on the programmable streaming multiprocessor (SM) 640. The pipeline manager 610 may also be configured to route packets received from the work distribution unit 525 to the appropriate logical units within the GPC 550. For example, some packets may be routed to fixed function hardware units in the PROP 615 and/or raster engine 625 while other packets may be routed to the DPCs 620 for processing by the primitive engine 635 or the SM 640. In an embodiment, the pipeline manager 610 may configure at least one of the one or more DPCs 620 to implement a neural network model and/or a computing pipeline.

The PROP unit 615 is configured to route data generated by the raster engine 625 and the DPCs 620 to a Raster Operations (ROP) unit, described in more detail in conjunction with FIG. 6B. The PROP unit 615 may also be configured to perform optimizations for color blending, organize pixel data, perform address translations, and the like.

The raster engine 625 includes a number of fixed function hardware units configured to perform various raster operations. In an embodiment, the raster engine 625 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x,y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 625 comprises fragments to be processed, for example, by a fragment shader implemented within a DPC 620.

Each DPC 620 included in the GPC 550 includes an M-Pipe Controller (MPC) 630, a primitive engine 635, and one or more SMs 640. The MPC 630 controls the operation of the DPC 620, routing packets received from the pipeline manager 610 to the appropriate units in the DPC 620. For example, packets associated with a vertex may be routed to the primitive engine 635, which is configured to fetch vertex attributes associated with the vertex from the memory 504. In contrast, packets associated with a shader program may be transmitted to the SM 640.

The SM 640 comprises a programmable streaming processor that is configured to process tasks represented by a number of threads. Each SM 640 is multi-threaded and configured to execute a plurality of threads (e.g., 32 threads) from a particular group of threads concurrently. In an embodiment, the SM 640 implements a SIMD (Single-Instruction, Multiple-Data) architecture where each thread in a group of threads (i.e., a warp) is configured to process a different set of data based on the same set of instructions. All threads in the group of threads execute the same instructions. In another embodiment, the SM 640 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 640 will be described in more detail below in conjunction with FIG. 7A.

The MMU 690 provides an interface between the GPC 550 and the partition unit 580. The MMU 690 may provide translation of virtual addresses into physical addresses, memory protection, and arbitration of memory requests. In an embodiment, the MMU 690 provides one or more translation lookaside buffers (TLBs) for performing translation of virtual addresses into physical addresses in the memory 504.

FIG. 6B illustrates a memory partition unit 580 of the PPU 500 of FIG. 5, in accordance with an embodiment. As shown in FIG. 6B, the memory partition unit 580 includes a Raster Operations (ROP) unit 650, a level two (L2) cache 660, and a memory interface 670. The memory interface 670 is coupled to the memory 504. Memory interface 670 may implement 32, 64, 128, 1024-bit data buses, or the like, for high-speed data transfer. In an embodiment, the PPU 500 incorporates U memory interfaces 670, one memory interface 670 per pair of partition units 580, where each pair of partition units 580 is connected to a corresponding memory device 504. For example, PPU 500 may be connected to up to Y memory devices 504, such as high bandwidth memory stacks or graphics double-data-rate, version 5, synchronous dynamic random access memory, or other types of persistent storage.

FIG. 7A illustrates the streaming multiprocessor 640 of FIG. 6A, in accordance with an embodiment. As shown in FIG. 7A, the SM 640 includes an instruction cache 705, one or more scheduler units 710(K), a register file 720, one or more processing cores 750, one or more special function units (SFUs) 752, one or more load/store units (LSUs) 754, an interconnect network 780, a shared memory/L1 cache 770.

As described above, the work distribution unit 525 dispatches tasks for execution on the GPCs 550 of the PPU 500. The tasks are allocated to a particular DPC 620 within a GPC 550 and, if the task is associated with a shader program, the task may be allocated to an SM 640. The scheduler unit 710(K) receives the tasks from the work distribution unit 525 and manages instruction scheduling for one or more thread blocks assigned to the SM 640. The scheduler unit 710(K) schedules thread blocks for execution as warps of parallel threads, where each thread block is allocated at least one warp. In an embodiment, each warp executes 32 threads. The scheduler unit 710(K) may manage a plurality of different thread blocks, allocating the warps to the different thread blocks and then dispatching instructions from the plurality of different cooperative groups to the various functional units (i.e., cores 750, SFUs 752, and LSUs 754) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (i.e., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (i.e., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 715 is configured to transmit instructions to one or more of the functional units. In the embodiment, the scheduler unit 710(K) includes two dispatch units 715 that enable two different instructions from the same warp to be dispatched during each clock cycle. In alternative embodiments, each scheduler unit 710(K) may include a single dispatch unit 715 or additional dispatch units 715.

Each SM 640 includes a register file 720 that provides a set of registers for the functional units of the SM 640. In an embodiment, the register file 720 is divided between each of the functional units such that each functional unit is allocated a dedicated portion of the register file 720. In another embodiment, the register file 720 is divided between the different warps being executed by the SM 640. The register file 720 provides temporary storage for operands connected to the data paths of the functional units.

Each SM 640 comprises L processing cores 750. In an embodiment, the SM 640 includes a large number (e.g., 128, etc.) of distinct processing cores 750. Each core 750 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 750 include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the cores 750. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each SM 640 also comprises M SFUs 752 that perform special functions (e.g., attribute evaluation, reciprocal square root, and the like). In an embodiment, the SFUs 752 may include a tree traversal unit configured to traverse a hierarchical tree data structure. In an embodiment, the SFUs 752 may include texture unit configured to perform texture map filtering operations. In an embodiment, the texture units are configured to load texture maps (e.g., a 2D array of texels) from the memory 504 and sample the texture maps to produce sampled texture values for use in shader programs executed by the SM 640. In an embodiment, the texture maps are stored in the shared memory/L1 cache 670. The texture units implement texture operations such as filtering operations using mip-maps (i.e., texture maps of varying levels of detail). In an embodiment, each SM 540 includes two texture units.

Each SM 640 also comprises N LSUs 754 that implement load and store operations between the shared memory/L1 cache 770 and the register file 720. Each SM 640 includes an interconnect network 780 that connects each of the functional units to the register file 720 and the LSU 754 to the register file 720, shared memory/ L1 cache 770. In an embodiment, the interconnect network 780 is a crossbar that can be configured to connect any of the functional units to any of the registers in the register file 720 and connect the LSUs 754 to the register file and memory locations in shared memory/L1 cache 770.

The shared memory/L1 cache 770 is an array of on-chip memory that allows for data storage and communication between the SM 640 and the primitive engine 635 and between threads in the SM 640. In an embodiment, the shared memory/L1 cache 770 comprises 128KB of storage capacity and is in the path from the SM 640 to the partition unit 580. The shared memory/L1 cache 770 can be used to cache reads and writes. One or more of the shared memory/L1 cache 770, L2 cache 660, and memory 504 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 770 enables the shared memory/L1 cache 770 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 5, are bypassed, creating a much simpler programming model. In the general purpose parallel computation configuration, the work distribution unit 525 assigns and distributes blocks of threads directly to the DPCs 620. The threads in a block execute the same program, using a unique thread ID in the calculation to ensure each thread generates unique results, using the SM 640 to execute the program and perform calculations, shared memory/L1 cache 770 to communicate between threads, and the LSU 754 to read and write global memory through the shared memory/L1 cache 770 and the memory partition unit 580. When configured for general purpose parallel computation, the SM 640 can also write commands that the scheduler unit 520 can use to launch new work on the DPCs 620.

The PPU 500 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 500 is embodied on a single semiconductor substrate. In another embodiment, the PPU 500 is included in a system-on-a-chip (SoC) along with one or more other devices such as additional PPUs 500, the memory 504, a reduced instruction set computer (RISC) CPU, a memory management unit (MMU), a digital-to-analog converter (DAC), and the like.

In an embodiment, the PPU 500 may be included on a graphics card that includes one or more memory devices 504. The graphics card may be configured to interface with a PCIe slot on a motherboard of a desktop computer. In yet another embodiment, the PPU 500 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 7B is a conceptual diagram of a processing system 700 implemented using the PPU 500 of FIG. 5, in accordance with an embodiment. The exemplary system 765 may be configured to implement the method 300 shown in FIG. 3. The processing system 700 includes a CPU 730, switch 710, and multiple PPUs 500 each and respective memories 504. The NVLink 510 provides high-speed communication links between each of the PPUs 500. Although a particular number of NVLink 510 and interconnect 502 connections are illustrated in FIG. 7B, the number of connections to each PPU 500 and the CPU 730 may vary. The switch 710 interfaces between the interconnect 502 and the CPU 730. The PPUs 500, memories 504, and NVLinks 510 may be situated on a single semiconductor platform to form a parallel processing module 725. In an embodiment, the switch 710 supports two or more protocols to interface between various different connections and/or links.

In another embodiment (not shown), the NVLink 510 provides one or more high-speed communication links between each of the PPUs 500 and the CPU 730 and the switch 710 interfaces between the interconnect 502 and each of the PPUs 500. The PPUs 500, memories 504, and interconnect 502 may be situated on a single semiconductor platform to form a parallel processing module 725. In yet another embodiment (not shown), the interconnect 502 provides one or more communication links between each of the PPUs 500 and the CPU 730 and the switch 710 interfaces between each of the PPUs 500 using the NVLink 510 to provide one or more high-speed communication links between the PPUs 500. In another embodiment (not shown), the NVLink 510 provides one or more high-speed communication links between the PPUs 500 and the CPU 730 through the switch 710. In yet another embodiment (not shown), the interconnect 502 provides one or more communication links between each of the PPUs 500 directly. One or more of the NVLink 510 high-speed communication links may be implemented as a physical NVLink interconnect or either an on-chip or on-die interconnect using the same protocol as the NVLink 510.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 725 may be implemented as a circuit board substrate and each of the PPUs 500 and/or memories 504 may be packaged devices. In an embodiment, the CPU 730, switch 710, and the parallel processing module 725 are situated on a single semiconductor platform.

In an embodiment, the signaling rate of each NVLink 510 is 20 to 25 Gigabits/second and each PPU 500 includes six NVLink 510 interfaces (as shown in FIG. 7B, five NVLink 510 interfaces are included for each PPU 500). Each NVLink 510 provides a data transfer rate of 25 Gigabytes/second in each direction, with six links providing 300 Gigabytes/second. The NVLinks 510 can be used exclusively for PPU-to-PPU communication as shown in FIG. 7B, or some combination of PPU-to-PPU and PPU-to-CPU, when the CPU 730 also includes one or more NVLink 510 interfaces.

In an embodiment, the NVLink 510 allows direct load/store/atomic access from the CPU 730 to each PPU’s 500 memory 504. In an embodiment, the NVLink 510 supports coherency operations, allowing data read from the memories 504 to be stored in the cache hierarchy of the CPU 730, reducing cache access latency for the CPU 730. In an embodiment, the NVLink 510 includes support for Address Translation Services (ATS), allowing the PPU 500 to directly access page tables within the CPU 730. One or more of the NVLinks 510 may also be configured to operate in a low-power mode.

FIG. 7C illustrates an exemplary system 765 in which the various architecture and/or functionality of the various previous embodiments may be implemented. The exemplary system 765 may be configured to implement the method 300 shown in FIG. 3.

As shown, a system 765 is provided including at least one central processing unit 730 that is connected to a communication bus 775. The communication bus 775 may be implemented using any suitable protocol, such as PCI (Peripheral Component Interconnect), PCI-Express, AGP (Accelerated Graphics Port), HyperTransport, or any other bus or point-to-point communication protocol(s). The system 765 also includes a main memory 740. Control logic (software) and data are stored in the main memory 740 which may take the form of random access memory (RAM).

The system 765 also includes input devices 760, the parallel processing system 725, and display devices 745, i.e. a conventional CRT (cathode ray tube), LCD (liquid crystal display), LED (light emitting diode), plasma display or the like. User input may be received from the input devices 760, e.g., keyboard, mouse, touchpad, microphone, and the like. Each of the foregoing modules and/or devices may even be situated on a single semiconductor platform to form the system 765. Alternately, the various modules may also be situated separately or in various combinations of semiconductor platforms per the desires of the user.

Further, the system 765 may be coupled to a network (e.g., a telecommunications network, local area network (LAN), wireless network, wide area network (WAN) such as the Internet, peer-to-peer network, cable network, or the like) through a network interface 735 for communication purposes.

The system 765 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 740 and/or the secondary storage. Such computer programs, when executed, enable the system 765 to perform various functions. The memory 740, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 765 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Machine Learning

Deep neural networks (DNNs) developed on processors, such as the PPU 500 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected perceptrons (e.g., nodes) that can be trained with enormous amounts of input data to quickly solve complex problems with high accuracy. In one example, a first layer of the DLL model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 500. Inferencing is less compute-intensive than training, being a latency-sensitive process where a trained neural network is applied to new inputs it has not seen before to classify images, translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 500 is a computing platform capable of delivering performance required for deep neural network-based artificial intelligence and machine learning applications.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system comprising:
a plurality of hardware processors;
a plurality of data storage entities; and
a circuit, in communication with the hardware processors and the data storage entities, that identifies a predetermined virtual address included within a read or write request received from one of the plurality of hardware processors and determines one of the plurality of data storage entities corresponding to the predetermined virtual address.

2. The system of claim 1, wherein the plurality of hardware processors includes one or more streaming multiprocessors.

3. The system of claim 1, wherein the plurality of hardware processors includes one or more central processing units (CPUs).

4. The system of claim 1, wherein each of the data storage entities includes a memory block comprising an individual memory sub-array located in a stacked configuration per-layer on top of one of the plurality of hardware processors.

5. The system of claim 1, wherein the data storage entities include one or more frame-buffer banks in a graphics processing unit (GPU).

6. The system of claim 1, wherein data storage entities include one or more memory channels in a central processing unit (CPU).

7. The system of claim 1, wherein data storage entities include one or more of flash memory, a storage disk, and a solid-state drive.

8. The system of claim 1, wherein the system is configured such that, given an N-dimensional array to be stored within the system, the N-dimensional array is mapped such that N-dimensional sub-arrays of the N-dimensional array are stored within a single data storage entity of the system.

9. The system of claim 1, wherein the system is configured such that a predetermined function is performed on bits of an address field for stored data to form a data storage entity address for the data that indicates one of the data storage entities storing the data and an offset location within the data storage entity for the data where the data is located within the data storage entity.

10. The system of claim 9, wherein the predetermined function includes a shuffle operation.

11. The system of claim 1, wherein the system is configured such that a segment descriptor is stored in a lookup table that is associated with a predetermined portion of a single data storage entity where an N-dimensional array is stored.

12. The system of claim 11, wherein the segment descriptor indicates how to use bits of a virtual address to identify the single data storage entity where the data is stored, as well as an offset location within the single data storage entity where the data is located.

13. The system of claim 11, wherein the system is configured such that a plurality of segment descriptors are stored in the lookup table, where each segment descriptor is associated with an N-dimensional matrix stored within one of the plurality of data storage entities.

14. The system of claim 1, wherein the system is configured such that, given an N-dimensional array to be stored within the system, N-dimensional sub-arrays of the N-dimensional array are mapped to a predetermined subset of the plurality of data storage entities.

15. A method comprising:
at a device:
receiving a virtual address included within a request;
identifying a portion of the virtual address as a segment number;
locating a segment descriptor in a lookup table, utilizing the segment number;
identifying, using the segment descriptor, a data storage entity and a starting location within the data storage entity; and
implementing the request utilizing the data storage entity and starting location within the data storage entity.

16. The method of claim 15, wherein the request includes a memory request comprising a read request or a write request.

17. The method of claim 15, wherein the portion of the virtual address identified as the segment number includes an address-spaced identifier (ASID) and high address bits of the virtual address.

18. The method of claim 15, wherein the lookup table is associative.

19. The method of claim 15, wherein the lookup table is indexed.

20. The method of claim 15, wherein the data storage entity includes a memory block comprising an individual memory sub-array that is located in a stacked configuration on top of a processor.

21. The method of claim 15, wherein the data storage entity is co-located with a processor that sent the request.

22. The method of claim 15, wherein the segment descriptor indicates how to use bits of the virtual address to identify a data storage sub-system via a sub-system address and an offset location within the data storage entity of the data storage sub-system where the data is located.

23. The method of claim 15, wherein the lookup table includes segment descriptors for a plurality of different memory segments.

24. A non-transitory computer-readable storage medium storing instructions that, when executed by a circuit, causes the circuit to:
receive a virtual address included within a request;
identify a portion of the virtual address as a segment number;
locate a segment descriptor in a lookup table, utilizing the segment number;
identify, using the segment descriptor, a data storage entity and a starting location within the data storage entity; and
implement the request utilizing the data storage entity and starting location within the data storage entity.

25. The computer-readable storage medium of claim 24, wherein the request includes a memory request comprising a read request or a write request.

26. The computer-readable storage medium of claim 24, wherein the portion of the virtual address identified as the segment number includes an address-spaced identifier (ASID) and high address bits of the virtual address.

27. The computer-readable storage medium of claim 24, wherein the lookup table is associative.

28. The computer-readable storage medium of claim 24, wherein the lookup table is indexed.

29. The computer-readable storage medium of claim 24, wherein the data storage entity includes a memory block comprising an individual memory sub-array that is located in a stacked configuration on top of a processor.

30. The computer-readable storage medium of claim 24, wherein the data storage entity is co-located with a processor that sent the request.

31. The computer-readable storage medium of claim 24, wherein the segment descriptor indicates how to use bits of the virtual address to identify a data storage sub-system via a sub-system address and an offset location within the data storage entity of the data storage sub-system where the data is located.

32. The computer-readable storage medium of claim 24, wherein the lookup table includes segment descriptors for a plurality of different memory segments.
